(19) United States
(12) Patent Application Publication
(10) Pub. No.: US 2020/0276740 A1
(43) Pub. Date: Sep. 3, 2020

(54) APPARATUS ASSOCIATED WITH AN INJECTION MOULDING MACHINE

(71) Applicant: ERMO, Mayenne (FR)

(72) Inventors: Pascal GIRAULT, Mayenne (FR); Luca GORI, Mayenne (FR); Massimo ROSSI, Mayenne (FR)

(73) Assignee: ERMO, Mayenne (FR)

(21) Appl. No.: 16/646,346

(22) PCT Filed: Sep. 18, 2018
(86) PCT No.: PCT/EP2018/075242

§ 371 Date: Mar. 11, 2020

(30) Foreign Application Priority Data
Sep. 18, 2017 (IT) 102017000104124

(51) Int. Cl. B29C 45/00

(52) U.S. Cl. CPC B29C 45/006; B29C 2045/1794

(57) ABSTRACT

An apparatus for coupling a first and a second part after they have been produced by injection moulding which includes: a linear runner, a carriage that is mounted on the runner, where it can make translations in a movement direction, and a pivoting member that is mounted cantilevered on the carriage in order to revolve in a planetary movement about a rotation axis perpendicular to the direction of movement of the carriage, so that the pivoting member revolving causes one of the two parts to turn over and enables it to be coupled with the other one. The motive part comprises a first electric drive mounted on the runner in order to move the carriage along the runner; and a second electric drive mounted on the carriage in order to cause the pivoting member to revolve so as to couple the two parts.

The present invention relates to an apparatus associated with an injection moulding machine for moulding objects made from plastics material.

As an example of application, we refer to the moulding of stoppers for bottles comprising a body and a lid that are joined by an integral hinge or by a shape fit. These stoppers are very widespread, for example in shampoo or detergent bottles or the like. The body of the stopper is mounted on the bottle and the lid is able to move between a closed position and an open position and vice versa.

Producing said stoppers by moulding requires a moulding machine having ever more advanced performances. As less than tenths of a second represent thousands of parts more per hour, with a more rapid paying-off of the equipment costs, the mould manufacturers have continually developed novel solutions. Two technologies have arisen: IMC (In-Mould Closing) and IMA (In-Mould Assembly), both aiming at the mould producing a stopper already ready to be mounted on the bottle for which it is intended, avoiding a manual or automated phase of closure thereof. With IMC the pivoting lid is closed on the hinge on the body, and with IMA the body and the lid are moulded and then, by moving parts of the mould, they are fitted one in the other.

The document WO 2016/141461 (HUSKY) describes an IMC system provided with a movable member for moving the lid on the body. The movable member is actuated linearly by two electric servomotors along two orthogonal axes. Control of the servomotors is very complex and this is not the ideal for imparting curved pathways on the movable member.

The documents U.S. Pat. No. 8,827,678 B2 and U.S. Pat. No. 7,874,830 B2 (ERMO) describe respectively an IMA system and an IMC system in which a pneumatic or electric drive 104 with a single alternately controlled axis moves a transferable carriage 108 and rotates a pivoting part. Switching of the mechanical power to the transferable carriage 108 or the pivoting part is obtained with bistable kinematics. This system does not offer very fine positional control, which means that positional control cannot deviate from what was decided in the design phase, since it is limited by the cams and in any event subject to wear.

One objective of the present invention is to propose a system for the moulding and assembly of two parts that does not have the drawbacks of the prior art.

To this end an apparatus is proposed for coupling a first part and a second part after they have been produced by injection moulding, wherein it is possible to couple the apparatus to a mould mounted on an injection moulding machine able to mould said parts, the apparatus comprising:
a linear runner;
a carriage that is mounted on the runner, where it can make translations in a movement direction;
a pivoting member that is mounted cantilevered on the carriage in order to revolve about an axis of revolution perpendicular to the direction of movement of the carriage, so that the revolution of the pivoting member causes one of the two parts to turn over and makes it possible to couple it with the other one;
a first electric drive mounted on the runner for moving the carriage along the runner;
a second electric drive mounted on the carriage in order to cause the pivoting member to revolve so as to couple the two parts.

In a preferred embodiment, the pivoting member is configured so as to revolve with a planetary movement about said perpendicular: this means that the pivoting member has its own longitudinal axis able to effect a revolution about said perpendicular axis while remaining at a certain distance therefrom.

In a preferred embodiment, the apparatus comprises two drives like the first drive, each being able to move in translation on a respective linear runner, the two runners being parallel and the pivoting member being mounted rotatably on each carriage and placed between the two carriages. Preferably, in this embodiment, the apparatus comprises two drives like the second drive, each drive being mounted on the corresponding carriage in order to rotate the pivoting member. In this way the balancing of the forces during the handling of the pivoting member is simplified and the precision of the placing thereof is improved.

In order to maximise savings, and in the case where the moulding machine does not comprise a second injection unit, there could be only one drive like the first drive. Having two of them does however simplify the balancing of forces (especially with two parallel runners) and improves the precision of the placing of the carriage. In the case where a single drive falls at the middle of the top portion of the mould, it is possible to use the system with dual drive.

In a preferred embodiment, the or each first and/or second drive is a rotary electric motor (another option is for example a linear actuator or motor).

In a preferred embodiment, the or each first rotary electric motor is connected to the respective carriage by means of a rotary threaded shaft mounted in engagement with a nut present in the carriage, a translation of the carriage corresponding to the rotation of the rotary threaded shaft.

In a preferred embodiment, the or each first rotary electric motor is connected to said pivoting member by means of a rotary threaded shaft mounted in engagement with a toothed wheel connected to the pivoting member, a rotation of the toothed wheel corresponding to the rotation of the rotary threaded shaft.

In a preferred embodiment, the first and/or the second drive comprises or consists of a rotary electric motor (another option is for example a linear actuator or motor).

In a preferred embodiment, in order to increase productivity, the apparatus comprises, on said two runners, a plurality of said pivoting members mounted in parallel and at a distance from each other, wherein the pivoting members are all connected to the same rotary shaft of one or each second drive.

Through the control of the first and second electric drives, it is possible to coordinate the path of the carriage and of the pivoting member in order to maximise productivity.

The apparatus can be adapted to produce a device in IMC (In-Mould Closing) or IMA (In-MouldAssembly) technology.

In the first case, the pivoting member is a bar, for example, in the case of stoppers, configured to come into contact with the lid and to push it onto the body. The bar preferably has portions with a larger diameter (“barrels”) corresponding to points intended to touch the cover in order to guarantee maximum extension of the contact and to avoid having to touch the edges of the stopper that have closed.

In the second case, the pivoting member is a mould portion in which the molten material is injected in order to mould the first part (for example a stopper lid), and then the mould portion is rotated in order to superimpose the first part and the second part (for example the body of a stopper) and to couple them to one another.

In a preferred embodiment, the apparatus comprises a logic unit (for example a microprocessor or an API) programmed to control the first and second electric drives and to coordinate the movements thereof. Automatic control of the electric motors, the apparatus offers numerous advantages, because electric motors afford very high performance and precision, which result in high productivity of the apparatus and of the moulding machine.

By means of the logic unit, it is possible to program the movement of one motor independently of the movement of the other motor, with the advantage that the pivoting member can have a very elaborate composite path suited to the application. The coordinated movements of the motors give more relative freedom to the project compared with documents U.S. Pat. No. 8,827,678 B2 and U.S. Pat. No. 7,874,830 B2, in which the movements are strictly a linear movement.

In particular, by means of the logic unit, it is possible to program the movement of the two motors so that the pivoting member has a composite path that remains contained inside a pre-established volume, a kind of safety limit that avoids impacts with obstacles or a component placed outside this volume.

Preferably, the apparatus comprises position sensors for determining the position of a carriage with respect to the respective runner and/or the angle of rotation of a pivoting member with respect to the carriage.

In a preferred embodiment for an IMC application, the logic unit is programmed:

a. to initially activate only the first drive, in order to move the pivoting member towards the part to be moved;

b. to deactivate the first drive and activate the second drive in order to shift the pivoting member and move one of the two parts;

c. to simultaneously activate the first drive and the second drive in order to return the assembly consisting a pivoting member and carriage to an idle position (of the start of the cycle).

In a preferred IMA application, the apparatus comprises:
a third drive, which can be implemented for example like the first or second drive, and
a second mould portion into which molten material is injected in order to mould the second part (for example the body of a stopper).

The third drive serves to move the second mould portion linearly along an axis orthogonal to the plane identified by said movement direction and said rotation axis, for the purpose of moving the second portion towards the portion included in the pivoting member and to join the first and second parts.

The third drive may be a handling element already included in the moulding machine, for example as an oil-hydraulic or mechanical drive (a means for expelling the parts), or another actuator that is actuated by compressed air, oil or electricity.

In the context of said preferred IMA application, in a variant the logic unit is programmed:
to initially activate only the first drive, in order to move the pivoting member containing the first part towards the second part;
next to activate the second drive at the same time as the first drive in order to shorten the path of the pivoting member (that is to say the pivoting member begins to rotate whereas it is still in a translation under the thrust of the first drive);
to continue to simultaneously activate the first drive and the second drive in order to bring the pivoting member above the second part;
next to activate only the third drive in order to fit the two parts one in the other.

In another IMA embodiment, it is possible first of all to rotate the pivoting member and next to move it in translation.

In another IMA embodiment, the logic unit is programmed:
to initially activate only the first drive, in order to move the pivoting member containing the first part towards the second part;
next to activate only the second drive while blocking the first drive, in order to turn over the pivoting member and to bring it above the second part;
next to activate only the third drive in order to fit the two parts one in the other.

Another aspect of the invention relates to an injection moulding machine provided with said apparatus.

The features of the invention, as well as others, will emerge more clearly from a reading of the following description of an embodiment by way of example, provided in relation to the accompanying drawings, among which:

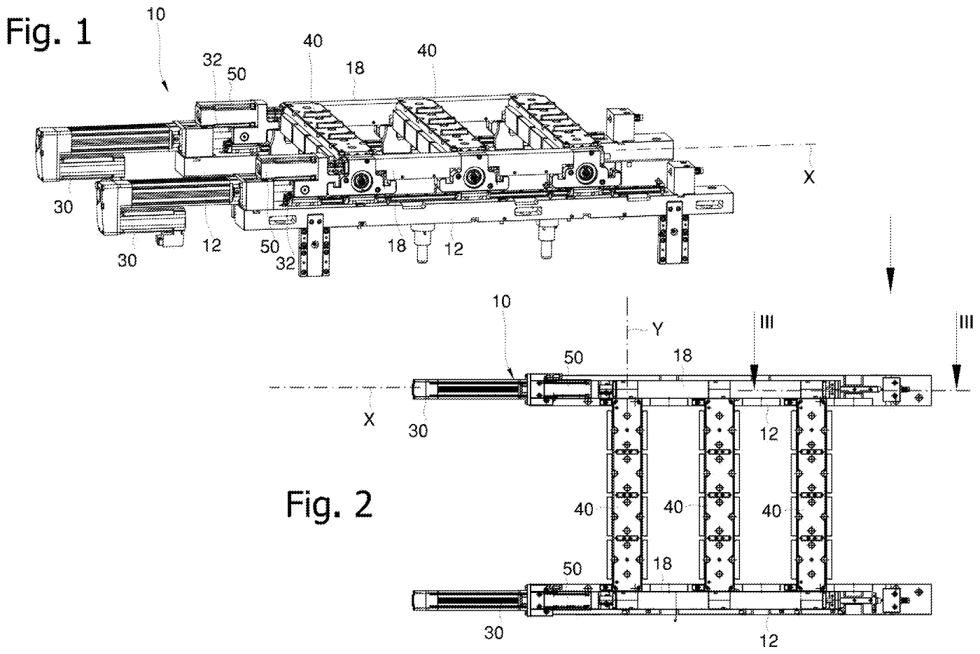

FIG. 1 shows a perspective view of a first moulding apparatus according to an embodiment in IMA technology;

FIG. 2 shows a plan view of the first apparatus;

FIG. 3 shows a view in cross section of the first apparatus along the plane III-III;

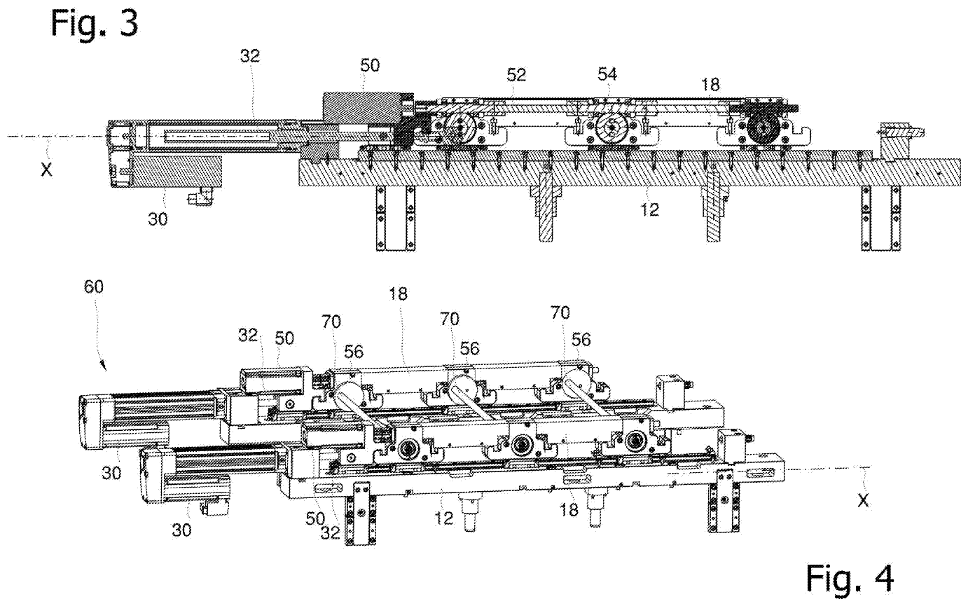

FIG. 4 shows a perspective view of a second moulding apparatus according to an embodiment in IMC technology;

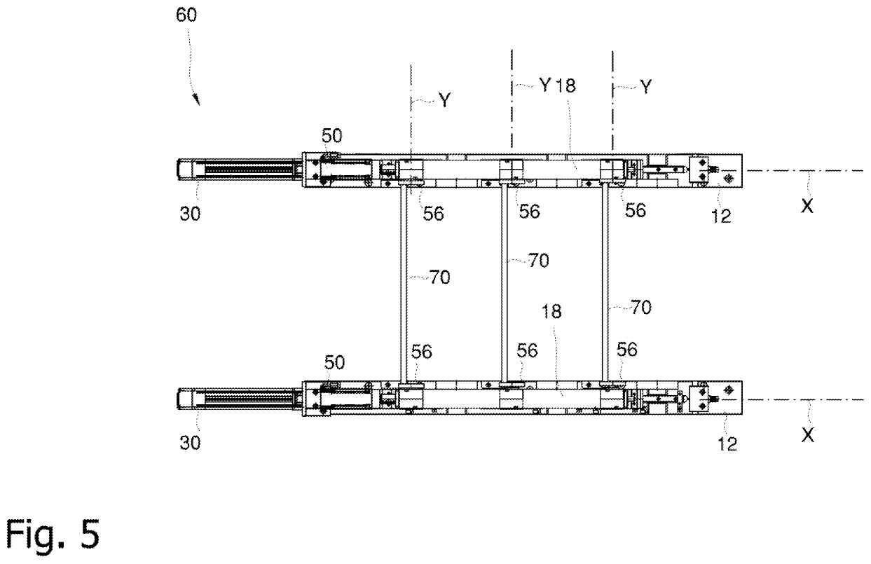

FIG. 5 shows a plan view of the second apparatus;

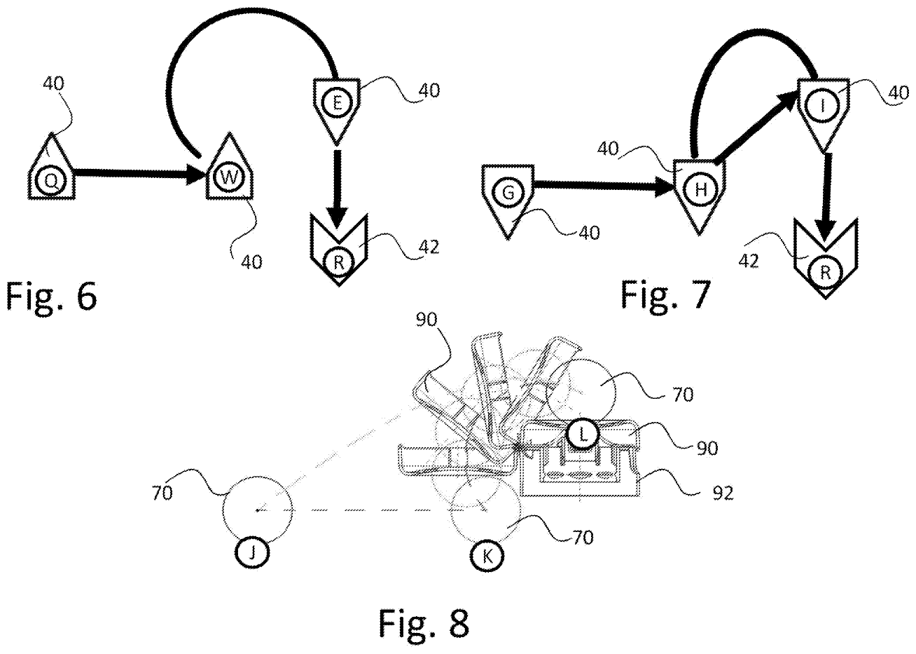

FIG. 6 shows a diagram of paths for the first apparatus;

FIG. 7 shows another diagram of paths for the first apparatus;

FIG. 8 shows a diagram of paths for the second apparatus.

A stopper consisting of a body (the first part) and a lid (the second part) is described as an example of a moulded object. The apparatus 10 and the apparatus 60 are associated with a known moulding machine and with an injection mould that are not depicted.

In the figures, identical references designate identical parts. In order not to burden the figures, only a few elements are marked with a reference.

FIG. 1 shows an apparatus 10 for moulding and mounting the lid and body of a stopper. The apparatus 10 comprises a base consisting mainly of two parallel runners 12. On the figures there are two runners 12, but, in the case of large installations, it is possible to produce additional runners.

On each runner 12 there is mounted a movable carriage 18 able to move longitudinally along the runner 12 while being pushed or pulled by an electric motor 30 along an axis X. The two carriages 18 are connected together at the middle by one or more mould portions 40 that extend between the two carriages 18 perpendicularly to the direction of movement of the carriages 18, along an axis Y.

The number of mould portions 40 varies according to the type of mould.

Each mould portion 40 is mounted on the carriage 18 so as to be able to revolve about the axis X with a planetary path, in other words it is offset eccentrically with respect to the axis Y. In this way the axis of the portion 40 revolves about the axis Y.

The electric motor 30 is of the rotary type and rotates a worm 32, the axis of which is parallel to X and which is in engagement with a corresponding nut in the carriage 18. Rotation of the worm 32 involves the advance of the carriage 18 on the runner 12 along the axis X.

On each carriage 18 there is mounted a second rotary electric motor 50, the output shaft of which rotates a worm 52, the axis of which is parallel to X and which is in engagement with the teeth on a toothed wheel 54 having the rotation axis Y. The toothed wheel 54 is connected to a disc or support that supports and rotates the portion 40.

The coordinated control of the motors 30, 50 enables the apparatus 10 to function in IMA mode. Please see the diagrams in FIGS. 6 and 7, which illustrate a few types of path imposed on the portion 40.

In FIG. 6, the portion 40 is initially moved along the axis X, by activation of the motor 30, from a position Q to a position W. Then the motor 30 is stopped and the portion 40 revolves eccentrically about the axis Y, under the effect of the activation of the motor 50, from the position W to a position E in which it is turned over vertically and is at a different height with respect to the runner 12.

Finally, another electric motor (not shown) is activated in order to vertically lower the portion 40 until it joins a die 42 that contains the body of the stopper (position R). Coupling of the portion 40 with the die 42 causes the lid and body of the stopper to fit together. The latter movement, that is to say the one that assembles the two parts, may also take place in the opposite direction, preferably executed by the part-ejection means situated on the moulding machine. Or said latter movement is effected by an external actuator.

In FIG. 7 the portion 40 is initially moved along the axis X, by activation of the motor 30, from a position G to a position H. Then the motor 50 is activated at the same time as the motor 30 and the coordinated movement thereof obtains a composite path for the portion 40. The latter commences for example to rise linearly with respect to the runner 12 or effects a parabola with its concavity turned downwards (end HI) while it revolves about the axis Y under the effect of the activation of the motor 50.

Finally, as before, the portion 40 is lowered vertically until it joins a die 42 for fitting together between lid and body. Here also the variant exists with an opposite direction of movement.

FIGS. 4 and 5 show another apparatus 60 for moulding and closing the lid 90 and body 92 of a stopper one on the other (FIG. 8). The lid 90 and the body 92 are moulded so as to be joined by an integral hinge. The cross section in FIG. 3 is also valid for the apparatus 60.

The apparatus 60 differs from the apparatus 10 only through the structure of the rotary part, and this is why we shall pass over the common details.

The two carriages 18 are connected together at the middle by one or more bars 70 that extend between the two carriages 18 perpendicularly to the direction of movement of the carriages 18. The number of bars 70 varies according to the type of mould.

The toothed wheel 54 is connected to a disc 56 that supports the bar 70 eccentrically and rotates it. Each bar 70 is then mounted on the carriage 18 so as to be able to revolve about an axis Y perpendicular to the axis X, while remaining at a certain distance from the axis Y. In other words each bar 70 is mounted on the carriage 18 so as to be able to revolves about the axis Y in a planetary movement.

The coordinated control of the motors 30, 50 enables the apparatus 60 to function in IMC mode.

Please see the diagram in FIG. 8, which illustrates a type of path imposed on the bar 70 (drawn by way of exemplification as a circle). The bar 70 is initially moved along the axis X, by activation of the motor 30, from a position J to a position K; in this phase the bar 70 has moved under the lid 90. Then the motor 30 is stopped and the bar 70 revolves about the axis Y, under the effect of the activation of the motor 50, from the position K to a position L. In revolving, the bar 70 pushes the lid 90 towards the body 92 until they couple with a click (position L). FIG. 8 also shows successive positions of the lid 90.

1. An apparatus for coupling a first part and a second part after they have been produced by injection moulding,
wherein the apparatus can be coupled to a mould mounted on an injection moulding machine able to mould said parts, the apparatus comprising:
a linear runner;
a carriage that is mounted on the runner, where it can make translations in a movement direction;
a pivoting member that is mounted cantilevered on the carriage in order to revolve about an axis of revolution perpendicular to the direction of movement of the carriage, so that the revolution of the pivoting member causes one of the two parts to turn over and makes it possible to couple it with the other one;
a first electric drive mounted on the runner for moving the carriage along the runner;
a second electric drive mounted on the carriage in order to cause the pivoting member to revolve so as to couple the two parts.

2. The apparatus according to claim 1, comprising two drives like the first drive, each being able to move in translation on a respective linear runner, the two runners being parallel and the pivoting member being mounted rotatably on each carriage and placed between the two carriages.

3. The apparatus according to claim 1, comprising two drives like the second drive, each drive being mounted on the corresponding carriage in order to cause the pivoting member to revolve.

4. The apparatus according to claim 1, wherein the or each first and/or second drive is a rotary electric motor.

5. The apparatus according to claim 4, wherein the or each first rotary electric motor is connected to the respective carriage by means of a rotary threaded shaft mounted in engagement with a nut present in the carriage, a translation of the carriage corresponding to the rotation of the rotary threaded shaft.

6. The apparatus according to claim 4, wherein the or each second rotary electric motor is connected to said pivoting member, by means of a rotary threaded shaft mounted in engagement with a toothed wheel connected to the pivoting member, a rotation of the toothed wheel corresponding to the rotation of the rotary threaded shaft.

7. The apparatus according to claim 1, wherein the pivoting member is a bar configured to come into contact with one part and to push it onto the other.

8. The apparatus according to claim 1, wherein the pivoting member is a mould portion into which the molten material is injected in order to mould the first part.

9. The apparatus according to claim 1, comprising a logic unit programmed to control the first and second electric drives and to coordinate the movements thereof in order to move the pivoting member so that the latter
in the translation thereof approaches the two parts, and
through its rotation causes the turning over of one of the two parts and makes it possible to couple it with the other one.
